(19) United States
(12) Patent Application Publication
(10) Pub. No.: US 2007/0219894 A1
(43) Pub. Date: Sep. 20, 2007

(54) Global opportunity fund

(76) Inventor: Eric-Vincent Guichard, Washington, DC (US)

Correspondence Address: MCKENNA LONG & ALDRIDGE LLP, 1900 K STREET, NW, WASHINGTON, DC, 20006, US

(21) Appl. No.: 11/717,783

(22) Filed: Mar. 14, 2007

Related U.S. Application Data
(60) Provisional application No. 60/781,707, filed on Mar. 14, 2006.

(51) Int. Cl. G06Q 40/00

(52) U.S. Cl. 705/36 R

(57) ABSTRACT

The Fund is structured as a fixed income note. Underlying the Fund is (a) a calibrated global fixed income index structured to generate 6%-8% per annum and (b) fund of private equity funds organized to generate short and frequent realizations. These short realizations fall under the category of secondaries, leverage buyouts and special situation deals.

This application claims the benefit of U.S. Provisional Patent Application No. 60/781,707, filed on Mar. 14, 2006, which is hereby incorporated by reference for all purposes as if fully set forth herein.

### BACKGROUND OF THE INVENTION

1. Field of the Invention

The present invention relates to structured finance and investments, and in particular to reduced risk investments with higher rates of return.

2. Discussion of the Related Art

The returns on private equity investments have typically exceed those of public and more liquid investments. However, despite its attractive returns, private equity is not available to all investors due to benefit payout requirements. Traditionally, private equity has long investment horizons (10-20 years depending upon asset class), it is relatively illiquid (little or no interim cash flow), and relatively undiversified (e.g. geographically, by sub-asset class). Furthermore, the operation of private equity investing presents other challenges for institutional investors. Industry practices require that each investor commit to a dollar (or other currency) amount. This amount is drawn down subject to calls by the private equity general partner—which are reflective of available underlying opportunities. To meet these sometimes untimely or unexpected calls, investors have to set aside their commitments into money market accounts or equivalent low yielding investments while waiting to invest the designated funds. These call periods can take years. In the interim period investors suffer significant opportunity loss as their capital languishes in cash. This is the opportunity cost of private equity investment.

In addition, in the early years of a private equity investment, investment returns are virtually always negative. This is because, as noted above, the private equity fund manager is drawing on capital cover its fees, but the investment portfolio has not yet matured enough to realize any gains, build value and offset these costs. When the private equity fund is more mature, realized gains make up for the fees, and the investment returns on the fund are positive. The industry calls this the J-Curve Effect, which is illustrated in FIG. 1.

Further, private equity is very risky. Principal invested can be totally lost. What is needed is a way to provide private equity like returns with minimum risk to principal and no J-curve effect.

### SUMMARY OF THE INVENTION

Accordingly, the present invention is directed to an investment fund that substantially obviates one or more of the problems due to limitations and disadvantages of the related art.

An advantage of the present invention is to converts private equity into a more accessible asset class for pensions and for other institutional investors.

Another advantage of the present invention is to mitigate the negative attributes of private equity to more closely align with investor profiles.

Another advantage of the present invention is to mitigate the negative carry J-Curve.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, an investment fund having at least one investor includes a private equity component having a plurality of private equity investments, said investment fund having committed a predetermined contribution to each of said private equity investments, said private equity component generating a positive return; a liquidity management component investing said predetermined contributions for each of the private equity investments into an liquidity vehicle providing a positive rate of return with substantially zero risk; and in which a portion of the liquidity vehicle corresponding to the amount of one of said contributions is sold when the private equity investment corresponding to that contribution calls on the committed contribution, wherein the returns from both the private equity component and the liquidity management component are passed through to the investor.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 illustrates the J-curve of conventional private equity investments and the curve of the investment of the present invention.

FIG. 2 illustrates the operation of the Fund of the present invention.

FIG. 3 illustrates the parties involved in the fund of the present invention.

### DETAILED DESCRIPTION OF THE ILLUSTRATED EMBODIMENTS

Reference will now be made in detail to an embodiment of the present invention, example of which is illustrated in the accompanying drawings.

The Global Opportunity Fund (or “Fund”) of the present invention is a tailored private equity access solution targeted at institutional investors unable to directly invest in private equity deals due to investment guideline limitations or lower risk tolerance thresholds. These Institutional Investors are desirous of the significant returns private equity investment can generate but in a controlled way.

In a first exemplary embodiment, the Fund buys principal insurance from a global bank which guarantees loss of principal at term. The Fund term, in a first exemplary example is 10 years with an optional 2 year extension. Each investor purchases a fixed income note from the principal insurer. The fixed income note serves the purpose of guaranteeing principal investment at term and also serves to convert underlying private equity investment into a fixed income note.

The Fund does not require calls or commitments. Each investor places the totality of their investments into the Fund's fixed income note. The Fund generates interim returns, which are paid to fixed income note investors as they are generated. In addition, the Fund generates private equity returns in lump sums which are also paid to note investors. Investors therefore receive interim cash flows and lump sum returns generated by private equity investments.

The Fund is structured as a fixed income note. Underlying the Fund is (a) a calibrated global fixed income index structured to generate 6%-8% per annum and (b) fund of private equity funds organized to generate short and frequent realizations. These short realizations fall under the category of secondaries, leverage buyouts and special situation deals.

The Fund optimally shifts funds between the index and the fund of private equity funds in such a way as to generate cash flows for investors. This interaction, coupled with capital access provided by the principal guarantor enables the Fund to generate, in aggregate, returns akin to direct private equity investments without the principal risk, nor the J-Curve effect.

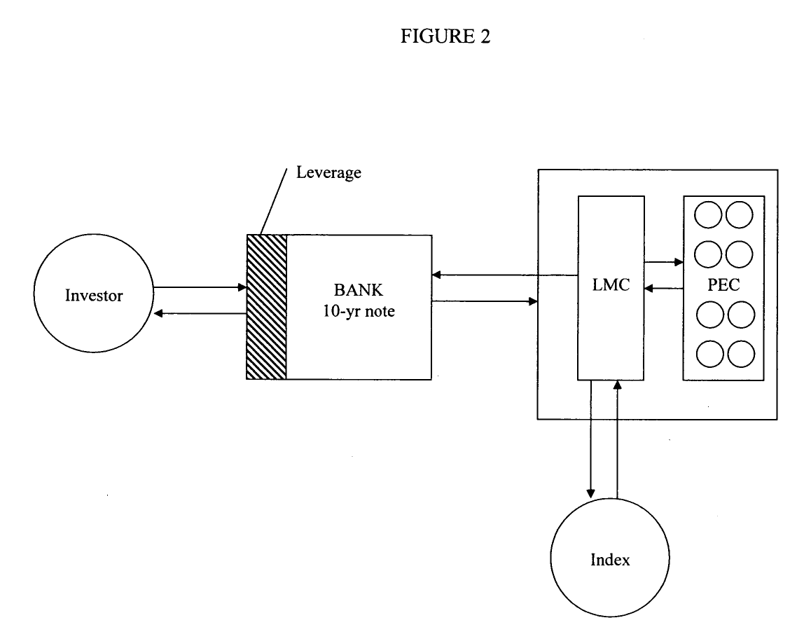

An embodiment of the present invention is illustrated in detail with reference to FIG. 2. In FIG. 2, the investor purchases a 10-year note from the Bank. In this example the coupon on the note is anywhere between 6%-8%. The Bank passes the invested amount (the purchase price of the note) to the Fund. The Fund has two internal components, a liquidity management component (LMC) and a private equity component (PEC). The PEC includes commitments made to a number of private equity (PE) investments, and thus acts as a private equity portfolio. The PE investments are selected so that the number of individual PE investments calling on committed capital do not fluctuate too greatly over time and so that too many do not all call on capital at once. In other words, the PE investments in the PE portfolio are selected so that the number calling on committed capital is roughly constant over time. PEC funds will focus primarily on the more liquid aspect of private equity, and in some exemplary embodiments, the PE portfolio can be replaced by a portfolio of funds or other private investments with a short turnover cycle, such as secondaries; special situations; distressed real estate; and leverage buyouts. Select allocations may also be made to other asset classes such as venture capital.

The PEC will have a strategic allocation among private equity funds focusing on various sectors and geographic regions. The objective is to achieve an optimal distribution among top funds that will together create a well-diversified portfolio. It is expected that the fund will provide a highly uncorrelated risk profile for pensions and other investors.

While the Fund has committed capital to the PE investments in the portfolio, the money is not turned over immediately. During this interim period, the Fund invests the investment capital in a liquidity management facility of the LMC. When capital calls come from underlying PEC sub-fund managers, allocations are made from the LMC exclusively. The LMC is a very high liquidity asset or group of assets which provides a positive rate of return with zero or near zero risk of principal loss. For example, such an investment could be a global fixed income index fund, which invests in the government debt of G12 nations returning between 6%-8%. Because the return on the LMC investment is at least equal to the coupon of the note issued by the Bank to the investor, there is no risk that the Bank will not be able to pay on the note. Therefore, during the interim period in which capital committed to the PE investments has not yet been turned over, the committed capital is earning a positive rate of return.

Investors have two ways to participate in the Fund: direct purchase of limited partnership interests, or purchase of a fixed income note linked to the performance of the fund.

Purchasing direct limited partnership interests occurs through a subscription agreement. Each investor receives interim annual cash flows, on a best efforts basis, comprised of any returns generated by the LMC and the PEC.

Investors can also purchase a fixed income note linked to the performance of the fund. The fixed income note consists of an obligation issued by a highly rated bank directly to the investor. The note's returns are linked to the Fund's underlying performance. This way, investors receive enjoy interim coupon returns and benefit from the upside generated by private equity returns.

Investors prospectively have the option to invest in the Fund through a CPPI principal protected note or bond. Under this option, investor principal will be guaranteed by a highly rated AA− or better bank. This feature will allow investors with strict risk parameters to consider an investment in the Fund because of the downside principal protection.

On a risk-reward basis, the Fund is expected to offer superior returns with relatively low risk when compared to traditional private equity investments, particularly when accessed via a CPPI note or bond.

Because the LMC invests in an asset (the global fixed income fund) with zero risk of principal loss, the Bank that issues the note will allow the fund to borrow, at the Bank's cost of capital, an amount of money equal to a portion or multiple of the net assets of the fund. The amount borrowed, i.e. the leverage, could be anywhere from one to two times the net assets, or even higher, depending on the arrangement between the bank and the fund. This leverage (the amount borrowed from the bank) is also invested in the LMC. Returns from the LMC are passed back through the Bank to the investor, along with any returns on the PE portfolio. The resulting returns to the investor which include the levered returns from the LM vehicle as well as the returns from the private equity investments, are much higher than other typical investments which guarantee no loss of principal.

Thus, the invention provides access to private equity-like returns with fixed income risk. The structure of the present invention thus provides principal protection and private equity returns, allows an asset class (private equity) to be converted from risky to tame, and eliminates the opportunity cost associated with private equity investments.

A further exemplary embodiment is presented as a case study scenario. Due to inherent risks, a government pension fund “X” restricts its investments in alternatives or private equity to a small percentage of its overall portfolio. An exacerbating benefits payout gap is, however, causing concern, and there is a need to increase returns. Pension fund “X” is presented with a dilemma: how can pension fund “X” achieve higher returns without violating its investment allocation and risk guidelines?

Private equity provides higher returns, but has several drawbacks: J-Curve Negative carry, a long-term investment horizon, inherent risk of investments, and relative illiquidity of investments during early years.

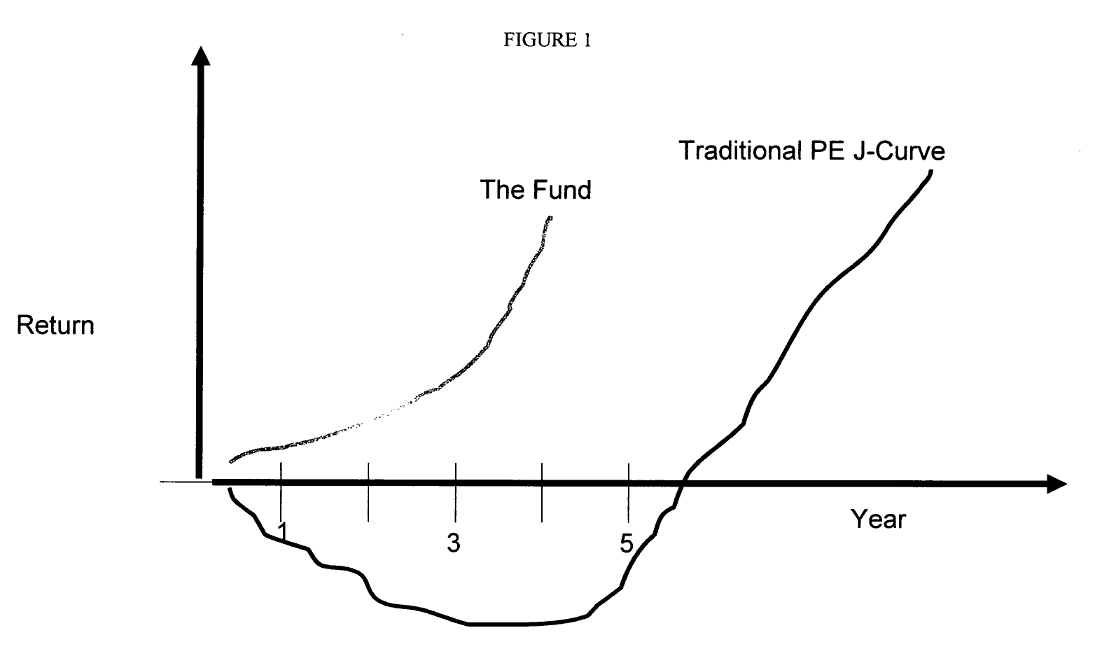

With the fund of the present invention, there is a solution. Pension Fund “X” allocates an investment to the Fund to achieve its return objectives in a single, efficient vehicle. Pension Fund “X” invests in a broad geographic (North America, Asia and emerging markets) and sub-asset class (secondaries, distressed assets, buyouts) mix to provide an optimally diversified portfolio. The Fund's LMC provides Pension “X” with annual interim coupon payments made on a best efforts basis that flatten the J-Curve's initial negative slope, shorten the pension's investment holding period, and mitigate overall investment risk. FIG. 1 illustrates the Fund's returns over time, showing no period of negative returns.

Through its mix of PE allocations, the PEC provides potential upside necessary to help close the benefits gap.

Pension “X” can invest through a fixed income wrap, directly as a limited partner or through a CPPI note. Pension “X” purchases a bank note or wrap directly from the issuing bank, which is tied to the underlying performance of the Fund. Pension “X” interfaces directly with the issuing bank and receives LMC and PEC cashflows.

Under another option, Pension “X” purchases an interest as a traditional PE limited partner interest via a standard subscription agreement. Pension “X” receives cash flows on a best efforts basis.

Pension “X” prospectively has the option to participate in the Fund through the purchase of a principally protected bank note or bond. The note is issued and fully backed by a highly rated bank that is providing the credit enhancement. This option gives Pension “X” full, downside protection. Pension “X” receives CPPI protection and comfort, together with LMC and PEC cashflows. Investing through the CPPI product mitigates the risk inherent in private equity investments, and effectively converts the private equity asset class to a fixed income instrument.

Now, through the Fund, investors previously restricted or prohibited from investing in PE can access that asset class' historic high returns, and do so within their existing investment guidelines and covenants.

Through effective asset class conversion, the Fund broadens access to PE and gives investors a tool to help meet critical future obligations.

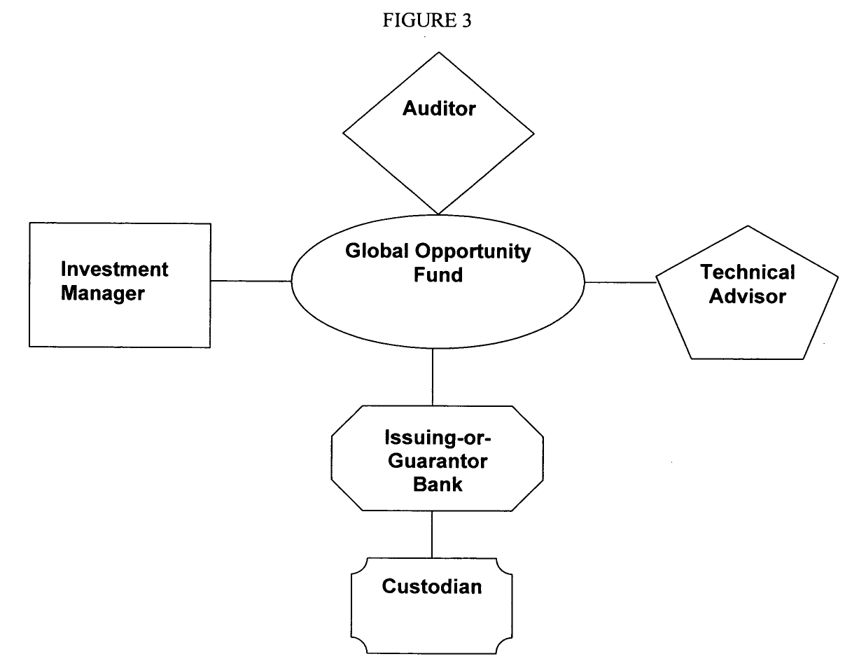

There are six key parties involved in the Fund: The Global Opportunity Fund, LTD, The Investment Advisor, The Issuing/Guarantor Bank, The Technical Advisor, The Custodian, and The External Auditors. The relationship between the parties is illustrated in FIG. 3.

Prospectively, the Fund may offer investors access to a liquidity repo facility offered by a guarantor bank. Given the traditional investment cycle of private equity that limits an investor's ability to withdraw capital prior to a redemption or other proscribed event, GCA recognizes that some clients may have concerns regarding the relatively illiquid nature of early PE investments.

As such, the Fund may prospectively offer a repo facility that lets institutions borrow from the guarantor bank at a preferential cost to meet short-to-medium term liquidity. The fee for tapping the liquidity/repo facility is expected to be approximately Libor+25 basis points. In today's market, that would mean an all-in rate of approximately 4.25% per annum, which is below the rate at which many of the Fund investors may themselves be able to access capital.

Investors may borrow up to 60% of the market value of their underlying invested funds. Tapping the facility is not expected to affect invested capital—that will continue to generate returns on behalf of the Fund investors, minus the cost of the facility (on a monthly basis) until full repayment.

In one embodiment, investors are expected to be able to tap the liquidity/repo facility with just five days' notice. Investors can participate in strategy conference calls with the investment advisor. Monthly NAV and quarterly performance reports may be generated for each investor.

Thus, the benefits of the Fund include that it converts private equity into a more accessible asset class for pensions and for other institutional investors, mitigates the negative attributes of private equity to more closely align with investor profiles, and allows those investors to potentially access higher private equity returns to meet existing and future obligations. Through the Liquidity Management Component, the negative carry J-Curve is mitigated, and the PEC offers investors flexibility to tailor portfolios to accurately reflect their investment guidelines and risk tolerances. Principal protection gives downside risk comfort.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. An investment fund having at least one investor, comprising:
a private equity component having a plurality of private equity investments, said investment fund having committed a predetermined contribution to each of said private equity investments, said private equity component generating a positive return;
a liquidity management component investing said predetermined contributions for each of the private equity investments into an liquidity vehicle providing a positive rate of return with substantially zero risk; and
a portion of the liquidity vehicle corresponding to the amount of one of said contributions is sold when the private equity investment corresponding to that contribution calls on the committed contribution,
wherein the returns from both the private equity component and the liquidity management component are passed through to the investor.
